(19) United States
(12) Patent Application Publication
(10) Pub. No.: US 2023/0038688 A1
(43) Pub. Date: Feb. 9, 2023

(54) PULVERIZED SOLID FUEL NOZZLE TIP ASSEMBLY WITH CARBON TIP PORTION

(71) Applicant: GENERAL ELECTRIC TECHNOLOGY GMBH, Baden (CH)

(72) Inventors: KEVIN GRZEBIEN, SOUTHWICK, MA (US); KENNETH RICHARD SMYTH, AGAWAM, MA (US); JOHN CHILDS LEWIS, FEEDING HILLS, MA (US)

(73) Assignee: GENERAL ELECTRIC TECHNOLOGY GMBH, BADEN (CH)

(21) Appl. No.: 17/392,702

(22) Filed: Aug. 3, 2021

(51) Int. Cl. B05B 15/18; B05B 7/00; B05B 7/14

(52) U.S. Cl. CPC B05B 15/18; B05B 7/0075; B05B 7/1486; F23K 3/02

(57) ABSTRACT

A pulverized solid fuel nozzle tip assembly for use with a pulverized solid fuel pipe nozzle to issue a stream of pulverized solid fuel and air to a pulverized solid fuel-fired boiler is described. The pulverized solid fuel nozzle tip assembly has an outer nozzle tip portion adapted to mount in supported relation with the pulverized solid fuel pipe nozzle, and a monolithic, ceramic, inner nozzle tip portion adapted for mounting within the outer nozzle tip portion to have secure tiltable movement. The outer nozzle has supporting surfaces that support surfaces of the inner nozzle tip portion to minimize the tilting forces transmitted to the inner nozzle tip portion during normal furnace operation, enhancing the wear resistance of the pulverized solid fuel nozzle tip assembly. The outer nozzle has an air shroud with multiple air passages to direct secondary air over an outer surface of the inner nozzle tip portion.

### BACKGROUND

### Technical Field

Embodiments of this disclosure relate generally to pulverized solid fuel-fired boilers that generate steam that may be used for power generation with steam driven generators, and more specifically, to an improved pulverized solid fuel nozzle tip assembly with a carbon tip for use with a pulverized solid fuel pipe nozzle to issue a stream of pulverized solid fuel and air to a combustion chamber within a pulverized solid fuel-fired boiler.

### Discussion of Art

A steam generator such as a pulverized solid fuel-fired boiler generally includes a plurality of nozzle arrangements through which pulverized coal is delivered into a firing system or combustion chamber of the boiler for combustion in order to produce steam that can be used to power a steam turbine drives a generator to produce electricity. The nozzle arrangements are typically disposed within windboxes, which may be located proximate to the corners of the boiler. Each nozzle arrangement can include a coal pipe nozzle to provide a stream of pulverized coal and air, and a nozzle tip, which protrudes into the boiler, to issue the stream of pulverized coal and air to the combustion chamber. The nozzle tip is typically hingedly connected to the main conduit portion of the coal pipe nozzle. To this extent, the nozzle tip can be varied in direction within the combustion chamber for temperature control purposes. For example, the nozzle tip can be tilted up and down to adjust the location of the generated flame or fireball within the combustion chamber to control the flame temperature, and changed clockwise or counterclockwise with respect to the flame in the center of the combustion chamber to alter the direction in which the stream of pulverized coal and air is supplied.

The environment in which the nozzle tip operates is extremely harsh due to the highly abrasive nature of the pulverized coal and the high temperatures of the hear associated with the flame generated in the combustion chamber. For example, the flow of the highly abrasive pulverized coal through the nozzle tip can rapidly wear away portions of the nozzle tip. In addition, the high temperatures of the heat associated with the flame in the combustion chamber and the flow of air provided by the structure of the nozzle tip produce high temperature gradients that can lead to extreme internal stresses. As a result, a typical solid fuel nozzle tip assembly used to issue a stream of pulverized coal and air to a pulverized coal-fired boiler has a low wear resistance that leads to failure of the nozzle tip. Moreover, a nozzle tip with a low wear resistance typically has a decreased service life that is generally beset with higher maintenance costs.

### BRIEF DESCRIPTION

The following presents a simplified summary of the disclosed subject matter in order to provide a basic understanding of some aspects of the various embodiments described herein. This summary is not an extensive overview of the various embodiments. It is not intended to exclusively identify key features or essential features of the claimed subject matter set forth in the Claims, nor is it intended as an aid in determining the scope of the claimed subject matter. Its sole purpose is to present some concepts of the disclosure in a streamlined form as a prelude to the more detailed description that is presented later.

The aforementioned drawbacks associated with the typical solid fuel nozzle tip assembly used to issue a stream of pulverized coal and air to a pulverized coal-fired boiler create the need for a nozzle tip that can better withstand the harsh environment in which it operates. The various embodiments provide a pulverized solid fuel nozzle tip assembly that overcomes the deficiencies associated with the typical solid fuel nozzle tip assembly. In particular, the pulverized solid fuel nozzle tip assembly of the various embodiments includes an outer nozzle tip portion, also referred to as a “driver”, that is adapted to mount in supported relation with a pulverized solid fuel pipe nozzle, and a monolithic, ceramic, inner nozzle tip portion, also referred to as a “body”, that is adapted to mount within the outer nozzle tip portion. To this extent, a flow channel of the inner nozzle tip portion is operative to receive the stream of pulverized solid fuel and air from the pulverized solid fuel pipe nozzle and issue this stream of solid fuel and air into the combustion chamber of the boiler, while the outer nozzle tip is operative to provide a secondary stream of air into the combustion chamber.

The outer nozzle tip portion can include a pair of opposing lateral sidewalls, a seal frame structure located interior to the pair of opposing lateral sidewalls and coupled therewith, and an air shroud adapted to receive a secondary stream of air. In one embodiment, the air shroud can include a first plurality of air passages located on the top of the seal frame structure, secured between the pair of opposing lateral sidewalls, and a second plurality of air passages located under the bottom of the seal frame structure, secured between the pair of opposing lateral sidewalls. To this extent, these plurality of air passages, which can be formed by spaced ribs vertically disposed about the top and bottom of the seal frame structure, produce different flow pathways for the secondary stream of air. In one embodiment, the plurality of air passages can direct the secondary stream of air over an outer surface of the inner nozzle tip portion, such as for example, the outer top and bottom surfaces of the inner nozzle tip portion.

The inner nozzle tip portion can be tiltably secured to the outer nozzle tip portion for longitudinal movement relative to the outer nozzle tip portion. In one embodiment, a pair of opposing lever pins can be used to tiltably secure the inner nozzle tip portion to the lateral sidewalls of the outer nozzle tip portion. For example, the lever pins can be placed in a corresponding pair of opposing lever pin mounting bores that extend through the lateral sidewalls of the outer nozzle tip portion and the sidewalls of the inner nozzle tip portion that face the lateral sidewalls of the outer nozzle tip portion, and bushings placed in each of the opposing lever pin mounting bores to rotatably support the lever pins. In one embodiment, the lever pins, the lever pin mounting bores, and the bushings can be positioned in a central location relative to the corresponding sidewalls on a lateral centerline to facilitate titling of the inner nozzle tip portion over a predetermined a tilt range.

The outer nozzle tip portion and the inner nozzle tip portion can each have supporting structures with complementary surfaces that operate cooperatively to maintain support of the inner nozzle tip portion within the outer nozzle tip portion during normal boiler operation. In one embodiment, the outer nozzle tip portion can have a supporting structure with a front surface contoured or profiled to define a plurality of spaced recesses, while the inner nozzle tip portion can have a supporting structure with a back surface contoured or profiled to define a plurality of spaced noses, rims, or protrusions. To this extent, the noses of the supporting structure of the inner nozzle tip portion can be seated correspondingly in the recesses of the supporting structure of the outer nozzle tip portion. This seating of the noses in the recesses provides an outer nozzle tip portion to inner nozzle tip portion contact surface at locations where the noses are correspondingly seated in the recesses, and at locations extending between the seating locations of the noses and the recesses. The outer nozzle tip portion to inner nozzle tip portion contact surfaces that arise from this configuration enlarge the surface area that the inner nozzle tip portion experiences and reduces the point contact load. As a result, tilting forces used to tilt the inner nozzle tip portion during normal operation can be applied to the outer nozzle tip portion. This minimizes the tilting forces applied to the inner nozzle tip portion that can lead to point contact loading and stress.

The pulverized solid fuel nozzle tip assembly of the various embodiments is an improvement over the typical solid fuel nozzle tip assembly used to issue a stream of pulverized solid fuel and air to a pulverized solid fuel-fired boiler. Specifically, the pulverized solid fuel nozzle tip assembly of the various embodiments has a high wear resistance due to the use of a ceramic material with the inner nozzle tip portion. Ceramics, as opposed to stainless steel, are better suited to withstand the high temperatures of the heat associated with the flame in the combustion chamber, in which the inner nozzle tip portion is disposed. In addition, the use of ceramics with the inner nozzle tip portion is better suited to endure the highly abrasive pulverized coal because of its high wear resistance. This ensures that the pulverized solid fuel nozzle tip assembly of the various embodiments can work for a longer period of time without the need for more frequent servicing. Accordingly, the pulverized solid fuel nozzle tip assembly of the various embodiments is expected to have an increased service life with reduced maintenance costs in comparison to the typical solid fuel nozzle tip assembly that has a low wear resistance, a shorter overall service life cycle, and more maintenance costs due to the servicing that is needed because of its low wear resistance from operating in an extremely harsh environment.

Another improvement associated with the pulverized solid fuel nozzle tip assembly of the various embodiments is that it provides an enhanced tilt range due to the use and positioning of the lever pins, the pin mounting bores, and the bushings that tiltably secure the inner nozzle tip portion to the outer nozzle tip portion.

In addition to providing an enhanced tilt range, the pulverized solid fuel nozzle tip assembly of the various embodiments minimizes the tilting forces that cause damage to the typical pulverized solid fuel nozzle tip assembly. In particular, the supporting structures of the outer nozzle tip portion and the inner nozzle tip portion, and their complementary surfaces, maintain support of the inner nozzle tip portion within the outer nozzle tip portion during normal boiler operation, such that the tilting forces used to tilt the inner nozzle tip portion are applied to the outer nozzle tip portion. This is due to the enlarged contact surface area that the inner nozzle tip portion experiences, which reduces point contact loading. As a result, the tilting forces that are applied to the inner nozzle tip portion will be minimized. Minimizing tilting forces in this manner inhibits point contact loading and stress to the inner nozzle tip portion.

The previously mentioned benefit of tolerating high temperatures through the use of ceramics is further enhanced by the feature of the air shroud associated with the outer nozzle tip portion. That is, the plurality of air passages provided by the air shroud enables the pulverized solid fuel nozzle tip assembly of the various embodiments to offer further cooling to the inner nozzle tip portion by delivering the secondary air towards the outer surfaces of the inner nozzle tip portion. Not only do the plurality of air passages help the pulverized solid fuel nozzle tip assembly of the various embodiments operate in extremely high temperatures, but these air passages in the outer nozzle tip portion make it possible to manufacture the nozzle tip assembly with lower overall manufacturing costs since the monolithic, ceramic inner nozzle tip portion can be fabricated without these air passages.

In accordance with one embodiment, a pulverized solid fuel nozzle tip assembly adapted for cooperative operation with a pulverized solid fuel pipe nozzle to issue a stream of pulverized solid fuel and air to a pulverized solid fuel-fired boiler is provided. The pulverized solid fuel nozzle tip assembly comprises: an outer nozzle tip portion adapted for mounting in supported relation with the pulverized solid fuel pipe nozzle, the outer nozzle tip portion having an inlet end, an outlet end, and a flow channel extending therethrough from the inlet end to the outlet end, wherein the outer nozzle tip portion includes: a pair of opposing lateral sidewalls; a seal frame structure located interior to the pair of opposing lateral sidewalls and coupled therewith, the seal frame structure having a top seal blade, a bottom seal blade, and a pair of opposing sidewall seal blades interconnected with the top seal blade and the bottom seal blade; and an air shroud adapted to receive a secondary stream of air, the air shroud having a first plurality of air passages located on the top seal blade of the seal frame structure, secured between the pair of opposing lateral sidewalls, and a second plurality of air passages located under the bottom seal blade of the seal frame structure, secured between the pair of opposing lateral sidewalls, both the first plurality of air passages and the second plurality of air passages are adapted to produce different flow pathways for the secondary stream of air; and a monolithic, ceramic, inner nozzle tip portion adapted for mounting within the outer nozzle tip portion, the inner nozzle tip portion having an inlet end, an outlet end, and a flow passageway formed therebetween, wherein the inner nozzle tip portion is tiltably secured to the outer nozzle tip portion for longitudinal movement relative to the outer nozzle tip portion, wherein the flow passageway of the inner nozzle tip portion is operative to receive the stream of pulverized solid fuel and air, and wherein the first and second plurality of air passages of the air shroud are operative to direct the secondary stream of air over an outer surface of the inner nozzle tip portion.

In accordance with another embodiment, a pulverized coal nozzle tip assembly adapted for cooperative operation with a pulverized coal pipe nozzle to issue a stream of pulverized coal and air to a coal-fired boiler is provided. The pulverized coal nozzle tip assembly comprises: an outer nozzle tip portion adapted for mounting in supported relation with the pulverized coal pipe nozzle, the outer nozzle tip portion having an inlet end, an outlet end, and a flow channel extending therethrough from the inlet end to the outlet end, wherein the outer nozzle tip portion includes: a pair of opposing lateral outer sidewalls; a pair of opposing lateral inner sidewalls located interior and parallel with the pair of opposing lateral outer sidewalls; a pair of spacer plates separating the pair of opposing lateral outer sidewalls and the pair of opposing lateral inner sidewalls; a seal frame structure located interior to the pair of opposing lateral inner sidewalls and coupled therewith, the seal frame structure having a top seal blade, a bottom seal blade, and a pair of opposing sidewall seal blades interconnected with the top seal blade and the bottom seal blade, wherein the pair of opposing lateral outer sidewalls and the pair of opposing lateral inner sidewalls extend vertically beyond the top seal blade and the bottom seal blade; and an air shroud adapted to receive a secondary stream of air, the air shroud having a first plurality of air passages located on the top seal blade of the seal frame structure, secured between the pair of opposing lateral outer sidewalls and the pair of opposing lateral inner sidewalls, and a second plurality of air passages located under the bottom seal blade of the seal frame structure, secured between the pair of opposing lateral outer sidewalls and the pair of opposing lateral inner sidewalls, both the first plurality of air passages and the second plurality of air passages are adapted to produce different flow pathways for the secondary stream of air; a monolithic, ceramic, inner nozzle tip portion adapted for mounting within the outer nozzle tip portion, the inner nozzle tip portion having an inlet end, an outlet end, and a flow passageway formed therebetween, wherein the flow passageway of the inner nozzle tip portion is operative to receive the stream of pulverized coal and air, and wherein the first and second plurality of air passages of the air shroud are operative to direct the secondary stream of air over an outer surface of the inner nozzle tip portion; and a pair of opposing lever pins operative to secure the inner nozzle tip portion to the pair of opposing lateral outer sidewalls, the pair of opposing lateral inner sidewalls, the pair of spacer plates, and the seal frame structure of the outer nozzle tip portion, wherein the inner nozzle tip portion is tiltably secured to the outer nozzle tip portion for longitudinal movement relative to the outer nozzle tip portion.

In accordance with yet another embodiment, a method of servicing a coal-fired boiler having a combustion chamber for combusting a stream of pulverized coal and air carried by an arrangement of pulverized coal pipe nozzles with pulverized coal nozzle tip assemblies to issue the stream into the combustion chamber. The method comprises: retrofitting the arrangement of pulverized coal pipe nozzles with one or more modified pulverized coal nozzle tip assembly, each modified pulverized coal nozzle tip assembly comprising: an outer nozzle tip portion adapted for mounting in supported relation with the pulverized coal pipe nozzle, the outer nozzle tip portion having an inlet end, an outlet end, and a flow channel extending therethrough from the inlet end to the outlet end, wherein the outer nozzle tip portion includes: a pair of opposing lateral outer sidewalls; a pair of opposing lateral inner sidewalls located interior and parallel with the pair of opposing lateral outer sidewalls; a pair of spacer plates separating the pair of opposing lateral outer sidewalls and the pair of opposing lateral inner sidewalls; a seal frame structure located interior to the pair of opposing lateral inner sidewalls and coupled therewith, the seal frame structure having a top seal blade, a bottom seal blade, and a pair of opposing sidewall seal blades interconnected with the top seal blade and the bottom seal blade, wherein the pair of opposing lateral outer sidewalls and the pair of opposing lateral inner sidewalls extend vertically beyond the top seal blade and the bottom seal blade; and an air shroud adapted to receive a secondary stream of air, the air shroud having a first plurality of air passages located on the top seal blade of the seal frame structure, secured between the pair of opposing lateral outer sidewalls and the pair of opposing lateral inner sidewalls, and a second plurality of air passages located under the bottom seal blade of the seal frame structure, secured between the pair of opposing lateral outer sidewalls and the pair of opposing lateral inner sidewalls, both the first plurality of air passages and the second plurality of air passages are adapted to produce different flow pathways for the secondary stream of air; a monolithic, ceramic, inner nozzle tip portion adapted for mounting within the outer nozzle tip portion, the inner nozzle tip portion having an inlet end, an outlet end, and a flow passageway formed therebetween, wherein the flow passageway of the inner nozzle tip portion is operative to receive the stream of pulverized coal and air, and wherein the first and second plurality of air passages of the air shroud are operative to direct the secondary stream of air over an outer surface of the inner nozzle tip portion; and a pair of opposing lever pins operative to secure the inner nozzle tip portion to the pair of opposing lateral outer sidewalls, the pair of opposing lateral inner sidewalls, the pair of spacer plates, and the seal frame structure of the outer nozzle tip portion, wherein the inner nozzle tip portion is tiltably secured to the outer nozzle tip portion for longitudinal movement relative to the outer nozzle tip portion.

### DRAWINGS

The present invention will be better understood from reading the following description of non-limiting embodiments, with reference to the attached drawings, wherein below:

FIG. 1 is a schematic representation of a steam generator such as a pulverized solid fuel-fired boiler that produces steam that can be used in power generation with a steam driven generator according to an embodiment of the present invention;

FIG. 2 is a schematic representation of a pulverized solid fuel nozzle assembly for providing a stream of pulverized solid fuel and air to the pulverized solid fuel-fired boiler depicted in FIG. 1 according to an embodiment of the present invention;

FIG. 3 is a more detailed view of a pulverized solid fuel nozzle tip assembly of the nozzle assembly depicted in FIG. 2 according to an embodiment of the present invention;

FIG. 4 is a perspective view showing a schematic representation of further details of the outer nozzle tip portion of the pulverized solid fuel nozzle tip assembly depicted in FIG. 3 according to an embodiment of the present invention;

FIG. 5 is a side, cross-sectional view of a portion of the pulverized solid fuel nozzle tip assembly depicted in FIG. 3 with further details showing the inner nozzle tip portion secured to the outer nozzle tip portion according to an embodiment of the present invention;

FIG. 6 is a side, cross-sectional view of a portion of the pulverized solid fuel nozzle tip assembly showing the seating of some of the supporting structures of the outer nozzle tip portion with the supporting structures of the inner nozzle tip portion, that provide outer nozzle tip portion to inner nozzle tip portion contact surfaces at various locations that direct tilting forces used to tilt the inner nozzle tip portion during normal operation to be applied to the outer nozzle tip portion according to an embodiment of the present invention;

FIG. 7 is a side, cross-sectional view of a portion of the pulverized solid fuel nozzle tip assembly schematically showing a tilt range that is obtained by securing the inner nozzle tip portion to the outer nozzle tip portion with a lever pin according to an embodiment of the present invention;

FIG. 8 is a side, cross-sectional view of a portion of the pulverized solid fuel nozzle tip assembly schematically showing a portion of the air shroud of the outer nozzle tip portion directing a stream of secondary air towards an outer surface of the inner nozzle tip portion according to an embodiment of the present invention; and

FIG. 9 is a side, cross-sectional view of a pulverized solid fuel nozzle assembly with a pulverized solid fuel nozzle tip assembly and a tilting link arm to manipulate the nozzle tip assembly according to an embodiment of the present invention.

### DETAILED DESCRIPTION

Example embodiments of the present invention will be described more fully hereinafter with reference to the accompanying drawings, in which some, but not all embodiments are shown. Indeed, the present invention may be embodied in many different forms and should not be construed as limited to the embodiments set forth herein; rather, these embodiments are provided so that this disclosure will satisfy applicable legal requirements. For like numbers may refer to like elements throughout.

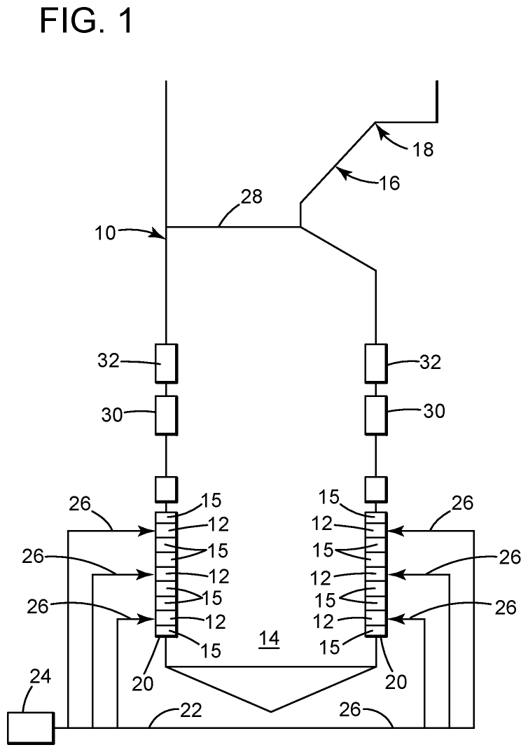

Turning now to the figures, FIG. 1 shows a schematic of a steam generator 10 that produces steam that can be used for power generation with a steam driven generator according to an embodiment of the present invention. In one embodiment, the steam generator 10 can include a pulverized coal-based fired boiler. Although the various embodiments are described with respect to a pulverized coal-based fired boiler that utilizes pulverized coal to generate steam for power generation applications, it is understood that the pulverized solid fuel nozzle tip assembly of the embodiments described herein can be used with other pulverized solid fuel-fired boilers that utilize a nozzle and pulverized solid fuel nozzle tip assembly to issue a stream of pulverized solid fuel into a firing system or combustion chamber for combustion of the fuel. Examples can include, but are not limited to, pulverized solid fuel-fired boilers that utilize other pulverized solid fuels such as biomass, wood, peat, grains, and coke. Like pulverized coal-fired boilers, these other types of pulverized solid fuel-fired boilers can be harsh environments for the respective solid fuel nozzle tip assemblies that issue these solid fuels, due to the high temperatures in which the fuels are combusted and the abrasive nature of these fuels.

As shown in FIG. 1, the steam generator 10 can include a combustion. chamber 14 within which the combustion of pulverized solid fuel (e.g., coal) and air is initiated. Hot gases that are produced from combustion of the pulverized solid fuel and air rise upwardly in the steam generator 10 and give up heat to fluid passing through tubes (not shown) that in conventional fashion line the walls of the steam generator. The hot gases exit the steam generator 10 through a horizontal pass 16 of the steam generator 10, which in turn leads to a rear gas pass 18 of the steam generator 10. Both the horizontal pass 16 and the rear gas pass 18 may contain other heat exchanger surfaces (not shown) for generating and superheating steam, in a manner well-known to those skilled in this art. The steam generated in the steam generator 10 may be made to flow to a turbine (not shown), such as used in a turbine/generator set (not shown) for power generation, or for any other desired purpose.

The steam generator 10 of FIG. 1 can also include one or more windboxes 20, which may be positioned in the corners of the steam generator 10. Each windbox 20 can have a plurality of air compartments 15 through which air supplied from a suitable source (e.g., a fan) is injected into the combustion chamber 14 of the steam generator 10. Also disposed in each windbox 20 is a plurality of fuel compartments 12, through which pulverized solid fuel is injected into the combustion chamber 14 of the steam generator 10.

The solid fuel is supplied to the fuel compartments 12 by a pulverized solid fuel supply 22, which includes a pulverizer 24 in fluid communication with the fuel compartments 12 via a plurality of pulverized solid fuel ducts 26. The pulverizer 24 is operatively connected to an air source (e.g., a fan), such that the air stream generated by the air source transports the pulverized solid fuel from the pulverizer 24, through the pulverized solid fuel ducts 26, through the fuel compartments 12, and into the combustion chamber 14 in a manner which is well known to those skilled in the art.

The steam generator 10 may be provided with two or more discrete levels of separated overfire air incorporated in each corner of the steam generator 10 so as to be located between the top of each windbox 20 and a boiler outlet plane 28 of the steam generator 10, thereby providing a low level of separated overfire air 30 and a high level of separated overfire air 32.

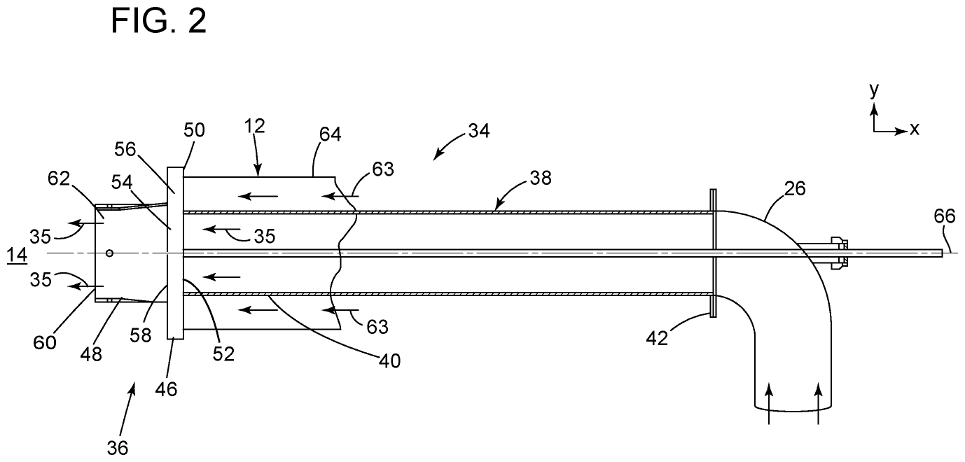

FIG. 2 is a schematic representation of a pulverized solid fuel nozzle assembly 34 for providing a stream of pulverized solid fuel and air 35 to a pulverized solid fuel-fired boiler like the steam generator 10 depicted in FIG. 1 according to an embodiment of the present invention. In particular, FIG. 2 shows a cross-sectional, elevation view of the pulverized solid fuel nozzle assembly 34 disposed within a fuel compartment 12 as taken along an x-y plane. While only one fuel compartment 12 is shown, it will be appreciated that each fuel compartment 12 of FIG. 1 may include a pulverized solid fuel nozzle assembly 34.

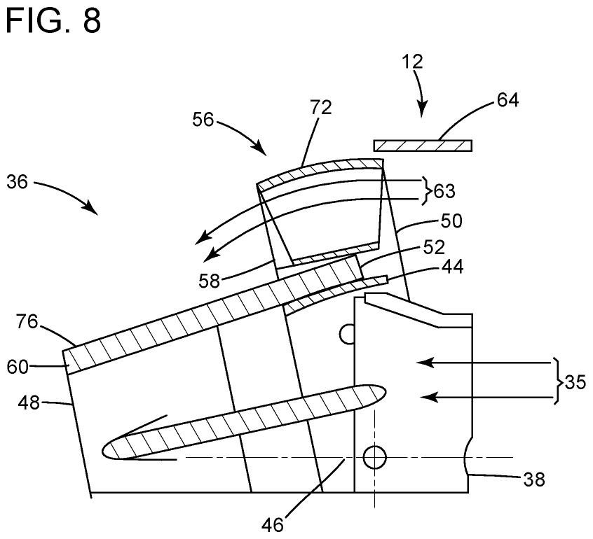

As shown in FIG. 2, the pulverized solid fuel nozzle assembly 34 can include a nozzle tip assembly 36, which protrudes into the combustion chamber 14, and a pulverized solid fuel pipe nozzle 38, which extends through the fuel compartment 12 and is coupled to a pulverized solid fuel duct 26. The pulverized solid fuel pipe nozzle 38 can comprise a generally rectangular shell 40 having a flange 42 disposed at one end for securing the pulverized solid fuel pipe nozzle 38 to the solid fuel duct 26, and a seal plate 44 (depicted in FIG. 8) disposed at the other end for providing a seal between the pulverized solid fuel pipe nozzle 38 and the nozzle tip assembly 36. By “generally rectangular,” it is meant that the inner surface of the shell 40 provides a flow path having a rectangular cross-section throughout much of the length of the shell. It is also contemplated that the cross section of the shell 40 may be of a different shape, such as of a circular shape.

The nozzle tip assembly 36 comprises an outer nozzle tip portion 46 adapted for mounting in supported relation with the pulverized solid fuel pipe nozzle 38 and a one-piece or monolithic, ceramic, inner nozzle tip portion 48 adapted for mounting within the outer nozzle tip portion 46. The outer nozzle tip portion 46 has an inlet end 50, an outlet end 58, a flow channel 54 extending there through from the inlet end to the outlet end, and an air shroud 56 with a plurality of air passages located about the inlet end, the outlet end, and the flow channel. The inner nozzle tip portion 48 has an inlet end 52, an outlet end 60, and a flow passageway 62 formed therebetween. The flow passageway 62 of the inner nozzle tip portion 48 is in fluid communication with the flow channel 54 of the outer nozzle tip portion 46. With this configuration, the inner nozzle tip portion 48 can receive the stream of pulverized solid fuel entrained in air 35 carried by the pulverized solid fuel pipe nozzle 38 for issuance to the combustion chamber 14 for combustion thereof, while the air passages of the air shroud 56 of the outer nozzle tip portion 46 are operative to receive a stream of secondary air 63 provided by a secondary air conduit 64. In this manner, the secondary air can be used in the combustion in the combustion chamber, and to help cool the outer surfaces of the inner nozzle tip portion 48. Further details of the outer nozzle tip portion 46 and the inner nozzle tip portion 48 are provided below.

It is understood that the pulverized solid fuel nozzle assembly 34 can be suitably supported within a fuel compartment 12, and any conventional mounting technique may be employed. Also, the secondary air conduit 64 may be coaxially aligned with a longitudinal axis 66 of the generally cylindrical shell 40, such that the pulverized solid fuel pipe nozzle 38 is centered within the secondary air conduit 64.

Also, it is contemplated that all or some of the components of the pulverized solid fuel nozzle assembly 34 may be dimensioned such that the nozzle assembly 34 can be used in place of an existing, prior art nozzle assembly. For example, it will be appreciated that the nozzle tip assembly 36 according to the various embodiments described herein can thus be retrofitted into an existing nozzle assembly of a steam generator with minimal modification to existing windbox controls or operation. It is also contemplated that the nozzle tip assembly 36 can be used with new nozzle assembly installations.

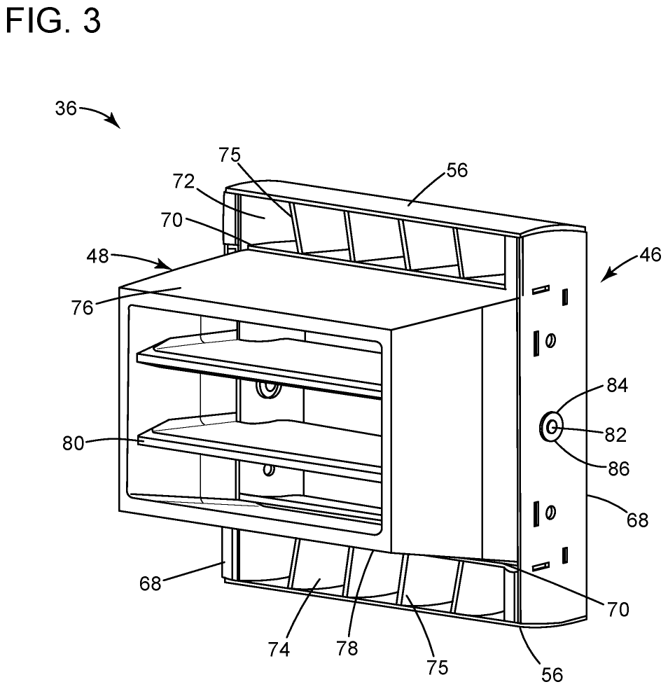

FIG. 3 is a more detailed view of the pulverized solid fuel nozzle tip assembly 36 depicted in FIG. 2 according to an embodiment of the present invention. In particular, FIG. 3 shows further details associated with the outer nozzle tip portion 46, which can be referred to as a “driver” because it receives the forces from a tilt link 112 to manipulate the nozzle tip assembly through the full tilt range while minimizing the forces on the relatively brittle ceramic body, and the inner nozzle tip portion 48 of the nozzle tip assembly 36, which can be referred to as a “body” since monolithic ceramic casting of this portion of the tip assembly delivers the mixed fuel and air mixture from the coal nozzle to the boiler. In addition to the features described in FIG. 2, the nozzle tip assembly 36 is shown in FIG. 3 with a pair of opposing lateral sidewalls 68 and a seal frame structure 70 located interior to the pair of opposing lateral sidewalls, and coupled therewith. As shown in FIG. 3, the air shroud 56, which is adapted to receive the secondary stream of air 63 (FIG. 2) from the secondary air conduit 64 (FIG. 2), can have a first plurality of air passages 72 located on the top of the seal frame structure 70, secured between the pair of opposing lateral sidewalls 68, and a second plurality of air passages 74 located under the bottom of the seal frame structure 70, secured between the pair of opposing lateral sidewalls 68. Both the first plurality of air passages 72 and the second plurality of air passages 74 are defined by spaced ribs 75 vertically disposed about the top and bottom of the seal frame structure 70 to produce different flow pathways for the secondary stream of air. In one embodiment, the first and second plurality of air passages 72, 74 of the air shroud 56 are operative to direct the secondary stream of air over an outer surface of the inner nozzle tip portion 48. For example, the first plurality of air passages 72 can direct a portion of the secondary air over a top surface 76 of the inner nozzle tip portion 48 and the second plurality of air passages 74 can direct another portion of the secondary air over a bottom surface 78 of the inner nozzle tip portion 48.

As shown in FIG. 3, the inner nozzle tip portion 48 can have at least one splitter plate 80 operative to divide and direct the stream of pulverized solid fuel and air 35 (FIG. 2) into different pathways. In one embodiment, the splitter plate(s) 80, which can take the form of a baffle, can be disposed across the flow passageway 62 (FIG. 2) of the inner nozzle tip portion 48, aligned parallel to the longitudinal axis 66 (FIG. 2) to impart additional directional force to the stream of pulverized solid fuel and air to ensure a uniform distribution of the coal-air stream particularly when the nozzle tip assembly 36 is tilted away from a horizontal position.

In one embodiment, the inner nozzle tip portion 48 of the nozzle tip assembly 36 can comprise a monolithic structure made of a cast ceramic. A cast ceramic, as opposed to stainless steel, allows the inner nozzle tip portion 48 to better withstand the high temperatures of the heat associated with the flame in the combustion chamber in which the inner nozzle tip portion is disposed. In addition, the use of a cast ceramic makes the inner nozzle tip portion 48 better suited to endure the highly abrasive nature of a pulverized solid fuel such as pulverized coal because of its high wear resistance. Examples of cast ceramic materials that are suitable for use with the inner nozzle tip portion 48 are ceramics that can include, but are not limited to, silicon nitride, siliconized silicon carbide, mullite bonded silicon carbide alumina composite, alumina zirconia composites, and alumina composite with optimized fiber.

The outer nozzle tip portion 46 of the nozzle tip assembly 36 can be formed from stainless steel. An advantage to having the outer nozzle tip portion 46 formed from stainless steel, as opposed to a ceramic like the inner nozzle tip portion 48 is that impact resistance and tensile strength of stainless steel will be greater than a ceramic. Since the outer nozzle tip portion 46 will be accommodating the loading demands imposed on the nozzle tip assembly 36 as explained below in more detail, it is advantageous to have the outer nozzle tip portion 46 formed from stainless steel.

As mentioned above, the inner nozzle tip portion 48 can be tiltably secured to the outer nozzle tip portion 46 for longitudinal movement relative to the outer nozzle tip portion 46. As shown in FIG. 3, a pair of opposing lever pins 82 can be utilized to secure the inner nozzle tip portion 48 to the lateral sidewalls 68 of the outer nozzle tip portion 46. In one embodiment, each of the pair of opposing lever pins 82 can be positioned in a central location relative to the corresponding lateral sidewalls 68 and the seal frame structure 70 on a lateral centerline, to facilitate titling of the inner nozzle tip portion 48 over a predetermined a tilt range. The pair of opposing lever pins 82 can be disposed in a pair of opposing lever pin mounting bores 84, each extending through one of the corresponding lateral sidewalls 68 of the outer nozzle tip portion 46 and one of a pair of sidewalls of the inner nozzle tip portion 48, and the seal frame structure 70. A pair of bushings 86 can each be placed in one of the opposing lever pin mounting bores 84 to rotatably support one of the lever pins 82. With this arrangement, and suitable dimensions (e.g. thickness, diameters) for the lever pins 82, the lever pin mounting bores 84, and the bushings 86, the loads placed upon the nozzle tip assembly 36 during normal operation can be distributed in a load equalizing manner which reduces the risk that the tip assembly 36 will catastrophically fail due to point loading during tilting of the tip assembly.

In addition, this mounting arrangement for mounting the inner nozzle tip portion 48 to the outer nozzle tip portion 46 is advantageous for the nozzle tip assembly 36 in that it allows the tip assembly to successfully withstand the typical loading imposed during normal operation in the combustion chamber of the steam generator. This includes the loading imposed by tilting of the nozzle tip assembly 36 by a conventional nozzle tip tilting mechanism (not shown) that can include for example a tilting link arm. Further, the impact resistance and tensile strength of the nozzle tip assembly 36 through the outer nozzle tip portion 46, which can be formed of stainless steel, and the inner nozzle tip portion 48, which can be formed of a ceramic material, afford the nozzle tip assembly 36 with high wear resistance and tolerance of extremely high temperatures.

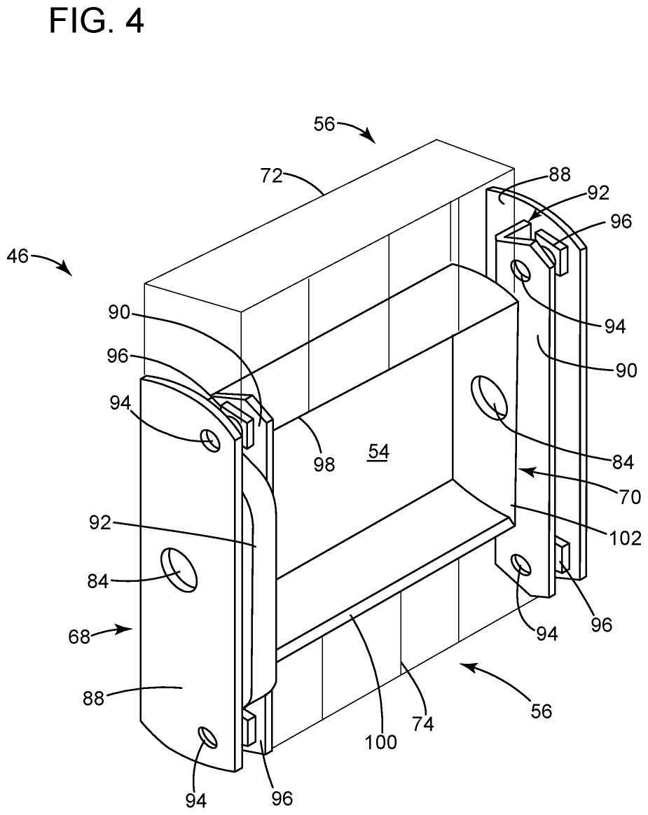

FIG. 4 is a perspective view showing a schematic representation of further details of the outer nozzle tip portion 46 of the pulverized solid fuel nozzle tip assembly 36 depicted in FIG. 3 according to an embodiment of the present invention. In particular, FIG. 4 shows more details associated with the lateral sidewalls 68. As shown in FIG. 4, the lateral sidewalls 68 of the outer nozzle tip portion 46 can have a pair of opposing lateral outer sidewalls 88, a pair of opposing lateral inner sidewalls 90 located interior and parallel with the pair of opposing lateral outer sidewalls 88, and a pair of spacer plates 92 separating the pair of opposing lateral outer sidewalls 88 and the pair of opposing lateral inner sidewalls 90. In one embodiment, the lateral outer sidewalls 88 and the lateral inner sidewalls 90 can take the form of brackets, and the spacer plates can take the form of braces. However, it is understood that the sidewalls and the spacer plates can be implemented in other forms that can include, but are not limited, castings, fabricated plate/sheet metal and 3D printed assemblies.

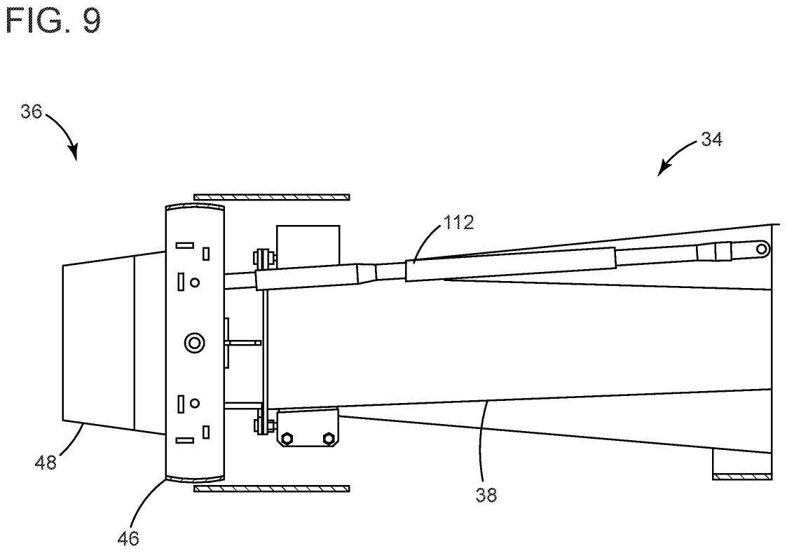

As shown in FIG. 4, the lateral outer sidewalls 88 and the lateral inner sidewalls 90 can each have a pair of sidewall interconnecting bores 94 formed thereon. For example, the pair of sidewall interconnecting bores 94 for both the lateral outer sidewalls 88 and the lateral inner sidewalls 90 can be vertically spaced apart from one another. The lateral outer sidewalls 88 can be secured to the lateral inner sidewalls 90 at a laterally outward spacing therefrom due to the separation provided by the spacer plates 92. For example, the lateral outer sidewalls 88 can be secured to the lateral inner sidewalls 90 by a fastener assembly. The fastener assembly can include the use of pins adapted for operative cooperation with the sidewall interconnecting bores 94 and 96 such that the lateral outer sidewalls 88 can be fixedly mounted to the lateral inner sidewalls 90 via the spacer plates 92. In one embodiment, a pin can be placed through the bores 94 and 96 to pin a tilting link arm 112 (FIG. 9) that tilts the nozzle tip assembly 36 in the fuel compartment 12 around the pulverized solid fuel pipe nozzle 38. It is understood that this fastener assembly is illustrative of one possibility and is not meant to be limiting. Some other examples of fastener assemblies that are suitable for use include, but are not limited to, castings, fabricated sheet-metal and 3D printed assemblies.

FIG. 4 also shows more details associated with the seal frame structure 70 of the outer nozzle tip portion 46. For example, as shown in FIG. 4, the seal frame structure 70 can include a top seal blade 98, a bottom seal blade 100, and a pair of opposing sidewall seal blades 102 interconnected with the top seal blade 98 and the bottom seal blade 100. In particular, the top seal blade 98 and the bottom seal blade 100 extend in spaced parallel relation to one, as does the sidewall seal blades 102. FIG. 4 shows that the seal frame structure 70 can be located interior to the pair of opposing lateral inner sidewalls 90 and coupled therewith and the pair of opposing lateral outer sidewalls 88 via the fastener assembly (e.g., pins and sidewall interconnecting bores 94 and 96). With this configuration, the seal frame structure 70 goes around the pulverized solid fuel pipe nozzle 38 to keep the pulverized fuel interior to the inner nozzle tip portion 48, and keep the secondary air 63 in the outer nozzle tip portion 46.

In one embodiment, the pair of opposing lateral outer sidewalls 88 and the pair of opposing lateral inner sidewalls 90 can extend vertically beyond the top seal blade 98 and the bottom seal blade 100. To this extent, the first plurality of air passages 72 of the air shroud 56 are located on the top seal blade 98 of the seal frame structure 70 secured between the pair of opposing lateral outer sidewalls 88 and the pair of opposing lateral inner sidewalls 90, and the second plurality of air passages 74 of the air shroud 56 are located under the bottom seal blade 100 of the seal frame structure 70 secured between the pair of opposing lateral outer sidewalls 88 and the pair of opposing lateral inner sidewalls 90.

As mentioned above, each of the pair of opposing lever pins 82 (FIG. 3) can be positioned in a central location relative to the corresponding lateral sidewalls of the outer nozzle tip portion 46 to facilitate titling of the inner nozzle tip portion 48 (FIGS. 2 and 3) over a predetermined a tilt range. FIG. 4 shows further details of this feature. In particular, FIG. 4 shows the lever pin mounting bores 84, which can receive the lever pins 82 and the bushings 86, can be positioned in a central location relative to the corresponding lateral outer sidewalls 88, lateral inner sidewalls 90, the spacer plates 92, and the sidewall seal blades 102 of the seal frame structure 70, on a lateral centerline to these components.

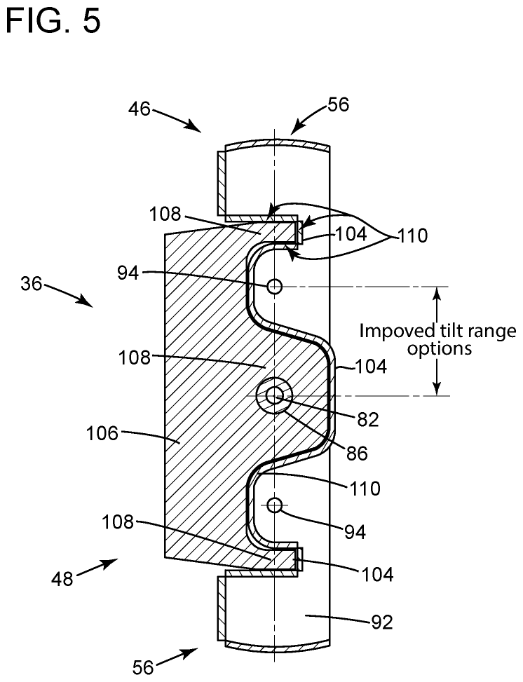

FIG. 5 is a side, cross-sectional view of a portion of the pulverized solid fuel nozzle tip assembly 36 depicted in FIG. 3 with further details showing the inner nozzle tip portion 48 secured to the outer nozzle tip portion 46 according to an embodiment of the present invention. As mentioned above, both the outer nozzle tip portion 46 and the inner nozzle tip portion 48 of the nozzle tip assembly 36 can each have supporting structures with complementary surfaces that operate cooperatively to maintain support of the inner nozzle tip portion 48 within the outer nozzle tip portion 46 during normal boiler operation. For example, the outer nozzle tip portion 46 can have a supporting structure with a front surface contoured or profiled to define a plurality of spaced recesses, while the inner nozzle tip portion 48 can have a supporting structure with a back surface contoured or profiled to define a plurality of spaced noses, rims, or protrusions. In this manner, the noses of the supporting structure of the inner nozzle tip portion 48 can be seated correspondingly in the recesses of the supporting structure of the outer nozzle tip portion 46. This seating of the noses in the recesses provides an outer nozzle tip portion to inner nozzle tip portion contact surface at locations where the noses are correspondingly seated in the recesses, and at locations extending between the seating locations of the noses and the recesses.

FIG. 5 shows an example of these supporting structures for the outer nozzle tip portion 46 and the inner nozzle tip portion 48. In one embodiment, the spacer plates 92 of the outer nozzle tip portion 46 can have a front surface that is a contoured surface that defines a plurality of spaced recesses 104. In the example, depicted in FIG. 5, the plurality of spaced recesses 104 can include a lower recess at a lower heightwise location in the spacer plates 92, an upper recess at an upper heightwise location, and a central recess centrally located between the lower recess and the upper recess. In one embodiment, the central recess can have a depth and a width that is greater than the depth and width of the lower recess and the upper recess.

The supporting structures for the inner nozzle tip portion 48 can include a pair of opposing sidewalls 106. For example, a back surface of each of the sidewalls 106 of the inner nozzle tip portion 48 can include a contoured surface that defines a plurality of spaced of noses 108. It is understood, the term nose is meant to cover other similarly shaped features that can include, but are not limited to, rims and protrusions. In the example, depicted in FIG. 5, the plurality of spaced noses 108 can include a lower nose at a lower heightwise location in the sidewalls 106 of the inner nozzle tip portion 48, an upper nose at an upper heightwise location, and a central nose centrally located between the lower nose and the upper nose. In one embodiment, the central nose can have a width that is greater than the width of the lower nose and the upper nose.

With these respective supporting structures, the inner nozzle tip portion 48 can be mounted securely within the outer nozzle tip portion 46. In particular, the lower nose, the upper nose, and the central nose of the inner nozzle tip portion 48 can be seated correspondingly in the lower recess, the upper recess, and the central recess of each of the spacer plates 92 of the outer nozzle tip portion 46 to provide an outer nozzle tip portion to inner nozzle tip portion contact surface 110 at locations where the noses 108 are correspondingly seated in the recesses 104 and at locations extending between the seating locations of the noses and the recesses. It is understood that these other locations due to the contoured surfaces with respect to the front surface of the spacer plates 92 and the back surface of the sidewalls 106 of the inner nozzle tip portion 48 will have a complementary profile to facilitate the seating of the inner nozzle tip portion 48 with the outer nozzle tip portion 46. In particular, these other locations representative of contact surfaces can include noses 108 for the spacer plates 92, and recesses for the sidewalls 106 of the inner nozzle tip portion 48. In this manner, the contoured surfaces of the spacer plates 92 and the sidewalls 106 can include an alternating pattern of noses placed between recesses.

It is understood that the number of recesses and noses illustrated herein for both the outer nozzle tip portion 46 and the inner nozzle tip portion 48 is only illustrative. Those skilled in the art will appreciate that the outer nozzle tip portion 46 and the inner nozzle tip portion 48 can be contoured to have additional or fewer noses and recesses. In addition, it is understood that the dimensions (e.g., widths and thicknesses can also vary. Moreover, it is understood that the outer nozzle tip portion 46 and the inner nozzle tip portion 48 can be profiled with other shapes to facilitate a secure mounting between these nozzle tip components.

Not only do the aforementioned supporting structures of the inner nozzle tip portion 48 (i.e., the contoured back surface of the sidewalls 106) and the outer nozzle tip portion 46 (i.e., the contoured front surface of the spacer plates 92) enable the inner nozzle tip portion 48 to be mounted securely within the outer nozzle tip portion 46, but these supporting structures also have a further benefit in that the outer nozzle tip portion to inner nozzle tip portion contact surfaces 110 can direct tilting forces used to tilt the inner nozzle tip portion 48 during normal operation to be applied to the outer nozzle tip portion 46. This minimizes the tilting forces applied to the inner nozzle tip portion 48 that can lead to point contact loading and stress to the inner nozzle tip portion 46.

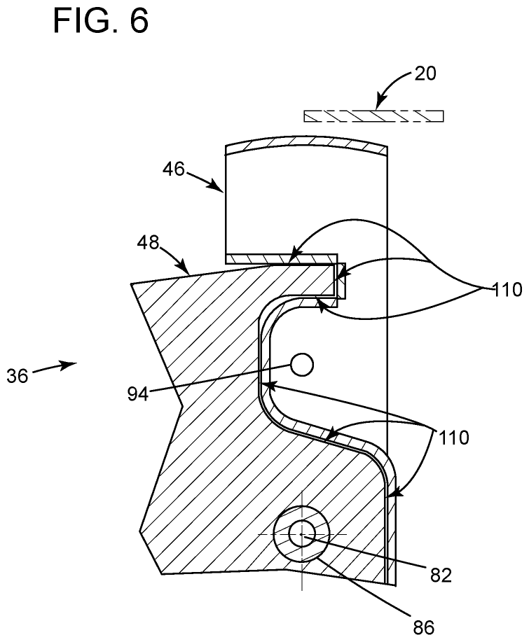

FIG. 6 is a side, cross-sectional view of a portion of the pulverized solid fuel nozzle tip assembly 36 showing the beneficial effect that the outer nozzle tip portion to inner nozzle tip portion contact surfaces 110 can have with respect to directing tilting forces used to tilt the inner nozzle tip portion 48 to be applied to the outer nozzle tip portion 46. For example, FIG. 6 shows in one embodiment that the outer nozzle tip portion to inner nozzle tip portion contact surfaces 110 about the central recesses and central noses of the supporting structures of the outer nozzle tip portion 46 and the inner nozzle tip portion 48 will bear a majority of the forces used to tilt the inner nozzle tip portion 48. This is due to the relatively large surface area associated with this contact surface 110 because of the thicknesses and depths of the corresponding noses and recesses at this location. That is, because the supporting structures of the outer nozzle tip 46 are designed with maximized surface areas, the outer nozzle tip 46 can reduce the tilting forces that can damage the inner nozzle tip 48.

In another embodiment, the outer nozzle tip portion to inner nozzle tip portion contact surfaces 110 about the upper recesses and upper noses of the supporting structures of the outer nozzle tip portion 46 and the inner nozzle tip portion 48 can contribute with the bearing surfaces about the central locations to bear a majority of the forces used to tilt the inner nozzle tip portion 48.

Because the inner nozzle tip portion 48 is pinned at a center point, via the lever pins 82 and bushings 86, with a large surface area pin, and “driven” by large contact areas on the inlet end 58 (FIG. 2) of the inner nozzle tip portion 48, movement or tilting of the inner nozzle tip portion 48 can be accomplished in a manner that directs forces needed to tilt the nozzle tip assembly 36 to be applied to the outer nozzle tip portion 46 (i.e., the driver). This increases the bearing surface to the single or monolithic, ceramic front piece (i.e., the inner nozzle tip portion 48). As a result, the possibility of point contact loading that could over stress the ceramics associated with the inner nozzle tip portion 48 is reduced. Moreover, because the inner nozzle tip portion 48 only needs to pivot its own mass due to the aforementioned method of attachment, the inner nozzle tip portion 48 will encounter little to no forces from the tilting mechanism (e.g., a tilting link arm, which is to be attached to the outer nozzle tip portion 46 and used to manipulate tilting) during the tilting of the nozzle tip assembly 36.

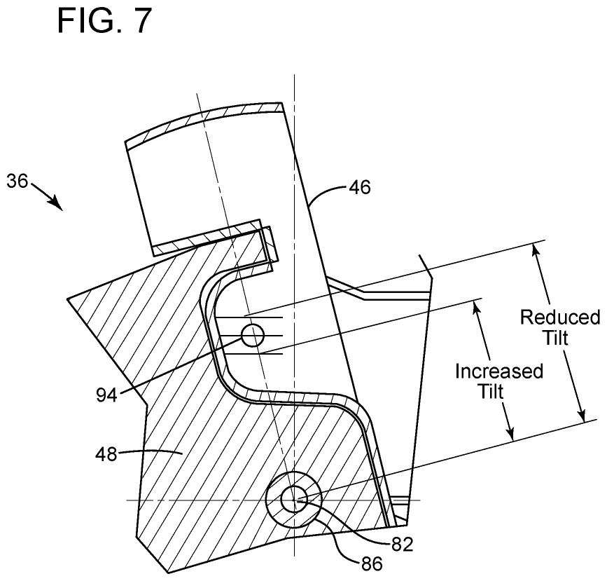

FIG. 7 is a side, cross-sectional view of a portion of the pulverized solid fuel nozzle tip assembly 36 schematically showing a tilt range that is obtained by securing the inner nozzle tip portion 48 to the outer nozzle tip portion 46 with a lever pin 82. The tilt range according to the various embodiments can be dictated by the distance of the sidewall interconnecting bore 94 from the lever pin 82. For example, FIG. 7 shows that having the lever pin 82 closer to the sidewall interconnecting bore 94 will result in an increased tilt range. Accordingly, multiple tilt positions can be obtained by varying the position of the sidewall interconnecting bores 94 versus the lever pins 82. In this manner, the various embodiments of the nozzle tip assembly 36 can have a predetermined tilt range that covers a wide range of tilt positions for the outer nozzle tip portion 46 that can be imparted to the inner nozzle tip portion 46.

This wide range of tilt positions is an improvement over the tilt ranges of conventional ceramic nozzle lip assemblies. In particular, the tilt angle can be modified by relocating the link arm attachment location in the driver (i.e., outer nozzle tip portion 46). This can save time and money by not having to modify the mold used to produce the ceramic body (i.e., inner nozzle tip portion 48) for different tilt range requirement.

FIG. 8 is a side, cross-sectional view of a portion of the pulverized solid fuel nozzle tip assembly 36 schematically showing a portion of the air shroud 56 of the outer nozzle tip portion 46 directing a stream of secondary air 63 towards an outer surface of the inner nozzle tip portion 48. As shown in FIG. 8, the first plurality of air passages 72 of the air shroud 56 can direct the stream of secondary air 63 towards the top outer surface 76 of the inner nozzle tip portion 48. In one embodiment, the first plurality of air passages 72 of the air shroud 56 can be configured with a curved outer portion to deflect the stream of secondary air 63 over the top surface 76 of the inner nozzle tip portion 48.

In this manner, the stream of secondary air 63 deflected towards the top outer surface 76 of the inner nozzle tip portion 48 by the curved outer portion of the passages 72 of the air shroud 56 will help with cooling the pulverized solid fuel nozzle tip assembly 36 when it is in a tilted or horizontal orientation as manipulated by a tilting link arm 112, of which is shown FIG. 9. In the example illustrated in FIG. 8, the tilting link arm 112 of FIG. 9 can be manipulated to operate the pulverized solid fuel nozzle tip assembly 36 in a downward pointed direction in relation to the pulverized solid fuel pipe nozzle 38, which carries the stream of pulverized solid fuel and air 35, and the secondary air conduit 64, which provides the stream of secondary air 63, both of which are in a fuel compartment 12.

It is understood that the level of cooling of the outer surface of the inner nozzle tip portion 48 by the passages 72 can be dictated by other features associated with these features. For example, the number of passages, the size of the passages, the materials of the passages, and shapes of the passages can all have a role in the degree of cooling that is provided to the outer surface of the inner nozzle tip portion 48.

Although not depicted in FIG. 8, it is understood that the secondary plurality of air passages 74 of the air shroud 56 shown in FIG. 3 that are adapted to direct the stream of secondary stream air 63 towards the bottom surface 78 of the inner nozzle tip portion 48 may operate in a similar manner as shown in FIG. 8. That is, the secondary plurality of air passages 74 of the air shroud 56 may be configured with a curved outer portion to deflect the stream secondary air 63 towards the bottom surface 78 of the inner nozzle tip portion 48.

There are several technical effects associated with the various embodiments. First, the pulverized solid fuel nozzle tip assembly of the various embodiments has a high wear resistance due to the use of a ceramic material with the inner nozzle tip portion. Ceramics, as opposed to stainless steel, is better suited to withstand the high temperatures of the heat associated with the flame in the combustion chamber in which the inner nozzle tip portion is disposed. In addition, the use of ceramics with the inner nozzle tip portion is better suited to endure the highly abrasive pulverized coal because of its high wear resistance. This ensures that the pulverized solid fuel nozzle tip assembly of the various embodiments can work for a longer period of time without the need for more frequent servicing. Accordingly, the pulverized solid fuel nozzle tip assembly of the various embodiments is expected to have an increased service life with reduced maintenance costs in comparison to the typical solid fuel nozzle tip assembly that has a low wear resistance, a shorter overall service life cycle, and more maintenance costs due to the servicing that is needed because of its low wear resistance from operating in an extremely harsh environment.

Other technical effects associated with We pulverized solid fuel nozzle tip assembly of the various embodiments is that it provides an enhanced tilt range due to the use and positioning of the lever pins, the pin mounting bores, and the bushings that tiltably secure the inner nozzle tip portion to the outer nozzle tip portion.

In addition to providing an enhanced tilt range, the pulverized solid fuel nozzle tip assembly of the various embodiments minimize the tilting forces that cause damage to the typical pulverized solid fuel nozzle tip assembly. In particular, the supporting structures of the outer nozzle tip portion and the inner nozzle tip portion, and their complementary surfaces, maintain support of the inner nozzle tip portion within the outer nozzle tip portion during normal boiler operation, such that the tilting forces used to tilt the inner nozzle tip portion are applied to the outer nozzle tip portion. This is due to the enlarged contact surface area that the inner nozzle tip portion experiences, which reduces point contact loading. As a result, the tilting forces that are applied to the inner nozzle tip portion will be minimized. Minimizing tilting forces in this manner inhibits point contact loading and stress to the inner nozzle tip portion.

The previously mentioned benefit of tolerating high temperatures through the use of ceramics is further enhanced by the feature of the air shroud with the outer nozzle tip portion. That is, the plurality of air passages provided by the air shroud enables the pulverized solid fuel nozzle tip assembly of the various embodiments to offer further cooling to the inner nozzle tip portion by delivering the secondary air towards the outer surfaces of the inner nozzle tip portion. Not only do the plurality of air passages help the pulverized solid fuel nozzle tip assembly of the various embodiments operate in extremely high temperatures, but these air passages in the outer nozzle tip portion make it possible to manufacture the nozzle tip assembly with lower overall manufacturing costs since the monolithic, ceramic inner nozzle tip portion can be fabricated without these air passages.

As a result of these benefits, which are apparent in comparison to a conventional nozzle tip assembly, the solution offered by the various embodiments is a cost effective design which can be implemented in accordance with a number of different options. For example, the outer nozzle tip portion of the nozzle tip assembly can be manufactured using a 3D printing process with a suitable material that meets the aforementioned material properties of the outer nozzle tip portion. In addition, the internal design of the ceramics for the inner nozzle tip portion of the nozzle tip assembly can be designed according to the specifications of the steam generator (e.g., the pulverized solid fuel-fired boiler). Furthermore, the outer nozzle tip portion of the nozzle lip assembly can have the option to be casted as opposed to being fabricated from a plate. These design options for the nozzle tip assembly make it suitable for boiler side removal which is beneficial for installation, as well as maintenance and service operations.

The above description of illustrated embodiments of the subject disclosure, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize. For example, parts, components, steps and aspects from different embodiments may be combined or suitable for use in other embodiments even though not described in the disclosure or depicted in the figures. Therefore, since certain changes may be made in the above-described invention, without departing from the spirit and scope of the invention herein involved, it is intended that all of the subject matter of the above description shown in the accompanying drawings shall be interpreted merely as examples illustrating the inventive concept herein and shall not be construed as limiting the invention.

In this regard, while the disclosed subject matter has been described in connection with various embodiments and corresponding figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below. For example, references to “one embodiment” of the present invention are not intended to be interpreted as excluding the existence of additional embodiments that also incorporate the recited features.

In the appended claims, the terms “including” and “in which” are used as the plain-English equivalents of the respective terms “comprising” and “wherein.” Moreover, in the following claims, terms such as “first,” “second,” “third,” “upper,” “lower,” “bottom,” “top,” etc. are used merely as labels, and are not intended to impose numerical or positional requirements on their objects. The terms “substantially,” “generally,” and “about” indicate conditions within reasonably achievable manufacturing and assembly tolerances, relative to ideal desired conditions suitable for achieving the functional purpose of a component or assembly. Further, the limitations of the following claims are not written in means-plus-function format and are not intended to be interpreted as such, unless and until such claim limitations expressly use the phrase “means for” followed by a statement of function void of further structure.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

What has been described above includes examples of systems and methods illustrative of the disclosed subject matter. It is, of course, not possible to describe every combination of components or methodologies here. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings, such terms are intended to be inclusive in a manner similar to the term “comprising” as “comprising” is interpreted when employed as a transitional word in a claim. That is, unless explicitly stated to the contrary, embodiments “comprising,” “including,” or “having” an element or a plurality of elements having a particular property may include additional such elements not having that property.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

Further aspects of the invention are provided by the subject matter of the following clauses:

A pulverized solid fuel nozzle tip assembly adapted for cooperative operation with a pulverized solid fuel pipe nozzle to issue a stream of pulverized solid fuel and air to a pulverized solid fuel-fired boiler, comprising: an outer nozzle tip portion adapted for mounting in supported relation with the pulverized solid fuel pipe nozzle, the outer nozzle tip portion having an inlet end, an outlet end, and a flow channel extending there through from the inlet end to the outlet end, wherein the outer nozzle tip portion includes: a pair of opposing lateral sidewalls; a seal frame structure located interior to the pair of opposing lateral sidewalls and coupled therewith, the seal frame structure having a top seal blade, a bottom seal blade, and a pair of opposing sidewall seal blades interconnected with the top seal blade and the bottom seal blade; and an air shroud adapted to receive a secondary stream of air, the air shroud having a first plurality of air passages located on the top seal blade of the seal frame structure, secured between the pair of opposing lateral sidewalls, and a second plurality of air passages located under the bottom seal blade of the seal frame structure, secured between the pair of opposing lateral sidewalls, both the first plurality of air passages and the second plurality of air passages are adapted to produce different flow pathways for the secondary stream of air; and a monolithic, ceramic, inner nozzle tip portion adapted for mounting within the outer nozzle tip portion, the inner nozzle tip portion having an inlet end, an outlet end, and a flow passageway formed therebetween, wherein the inner nozzle tip portion is tiltably secured to the outer nozzle tip portion for longitudinal movement relative to the outer nozzle tip portion, wherein the flow passageway of the inner nozzle tip portion is operative to receive the stream of pulverized solid fuel and air, and wherein the first and second plurality of air passages of the air shroud are operative to direct the secondary stream of air over an outer surface of the inner nozzle tip portion.

The pulverized solid fuel nozzle tip assembly of the preceding clause, further comprising a pair of opposing lever pins operative to secure the inner nozzle tip portion to the lateral sidewalls of the outer nozzle tip portion.

The pulverized solid fuel nozzle tip assembly of any of the preceding clauses, wherein each of the pair of opposing lever pins is positioned in a central location relative to the corresponding lateral sidewalls and the sidewall seal blades of the seal frame structure on a lateral centerline, to facilitate titling of the inner nozzle tip portion over a predetermined a tilt range.

The pulverized solid fuel nozzle tip assembly of any of the preceding clauses, further comprising: a pair of opposing lever pin mounting bores, each extending through one of the corresponding lateral sidewalls of the outer nozzle tip portion and one of a pair of sidewalls of the inner nozzle tip portion and the seal frame structure; and a pair of bushings, each placed in one of the opposing lever pin mounting bores to rotatably support one of the lever pins.

The pulverized solid fuel nozzle tip assembly of any of the preceding clauses, wherein the inner nozzle tip portion comprises at least one splitter plate disposed in the flow passage that is operative to divide and direct the stream of pulverized solid fuel and air into different pathways.

The pulverized solid fuel nozzle tip assembly of any of the preceding clauses, wherein the pair of opposing lateral sidewalls of the outer nozzle tip portion comprises: a pair of opposing lateral outer sidewalls; a pair of opposing lateral inner sidewalls located interior and parallel with the pair of opposing lateral outer sidewalls; and a pair of spacer plates separating the pair of opposing lateral outer sidewalls and the pair of opposing lateral inner sidewalls.

The pulverized solid fuel nozzle tip assembly of any of the preceding clauses, wherein the seal frame structure is located interior to the pair of opposing lateral inner sidewalls and coupled therewith, and wherein the pair of opposing lateral outer sidewalls and the pair of opposing lateral inner sidewalls extend vertically beyond the top seal blade and the bottom seal blade.

The pulverized solid fuel nozzle tip assembly of any of the preceding clauses, wherein the first plurality of air passages of the air shroud are located on the top seal blade of the seal frame structure secured between the pair of opposing lateral outer sidewalls and the pair of opposing lateral inner sidewalls, and the second plurality of air passages of the air shroud are located under the bottom seal blade of the seal frame structure secured between the pair of opposing lateral outer sidewalls and the pair of opposing lateral inner sidewalls.

The pulverized solid fuel nozzle tip assembly of any of the preceding clauses, wherein each of the spacer plates comprises a front surface having a contoured surface defining a plurality of spaced recesses.

The pulverized solid fuel nozzle tip assembly of any of the preceding clauses, wherein the plurality of spaced recesses comprises: a lower recess at a lower heightwise location; an upper recess at an upper heightwise location, and a central recess centrally located between the lower recess and the upper recess.

The pulverized solid fuel nozzle tip assembly of any of the preceding clauses, wherein the central recess comprises a depth and width that is greater than the depth and width of the lower recess and the upper recess.

The pulverized solid fuel nozzle tip assembly of any of the preceding clauses, wherein the inner nozzle tip portion comprises a pair of opposing sidewalls, each having a back surface with a contoured surface defining a plurality of spaced of noses.

The pulverized solid fuel nozzle tip assembly of any of the preceding clauses, wherein the plurality of spaced noses for each of the opposing sidewalls of the inner nozzle tip portion comprises: a lower nose at a lower heightwise location; an upper nose at an upper heightwise location; and a central nose centrally located between the lower nose and the upper nose.

The pulverized solid fuel nozzle tip assembly of any of the preceding clauses, wherein the lower nose, the upper nose, and the central nose are seated correspondingly in the lower recess, the upper recess, and the central recess of each of the spacer plates of the outer nozzle tip portion to provide an outer nozzle tip portion to inner nozzle tip portion contact surface at locations where the noses are correspondingly seated in the recesses, and at locations extending between the seating locations of the noses and the recesses.

The pulverized solid fuel nozzle tip assembly of any of the preceding clauses, wherein the outer nozzle tip portion to inner nozzle tip portion contact surface directs tilting forces used to tilt the inner nozzle tip portion to be applied to the outer nozzle tip portion, minimizing the tilting forces applied to the inner nozzle tip portion.

A pulverized coal nozzle tip assembly adapted for cooperative operation with a pulverized coal pipe nozzle to issue a stream of pulverized coal and air to a coal-fired boiler, comprising: an outer nozzle tip portion adapted for mounting in supported relation with the pulverized coal pipe nozzle, the outer nozzle tip portion having an inlet end, an outlet end, and a flow channel extending therethrough from the inlet end to the outlet end, wherein the outer nozzle tip portion includes: a pair of opposing lateral outer sidewalls; a pair of opposing lateral inner sidewalls located interior and parallel with the pair of opposing lateral outer sidewalls; a pair of spacer plates separating the pair of opposing lateral outer sidewalls and the pair of opposing lateral inner sidewalls; a seal frame structure located interior to the pair of opposing lateral inner sidewalls and coupled therewith, the seal frame structure having a top seal blade, a bottom seal blade, and a pair of opposing sidewall seal blades interconnected with the top seal blade and the bottom seal blade, wherein the pair of opposing lateral outer sidewalls and the pair of opposing lateral inner sidewalls extend vertically beyond the top seal blade and the bottom seal blade; and an air shroud adapted to receive a secondary stream of air, the air shroud having a first plurality of air passages located on the top seal blade of the seal frame structure, secured between the pair of opposing lateral outer sidewalls and the pair of opposing lateral inner sidewalls, and a second plurality of air passages located under the bottom seal blade of the seal frame structure, secured between the pair of opposing lateral outer sidewalls and the pair of opposing lateral inner sidewalls, both the first plurality of air passages and the second plurality of air passages are adapted to produce different flow pathways for the secondary stream of air; a monolithic, ceramic, inner nozzle tip portion adapted for mounting within the outer nozzle tip portion, the inner nozzle tip portion having an inlet end, an outlet end, and a flow passageway formed therebetween, wherein the flow passageway of the inner nozzle tip portion is operative to receive the stream of pulverized coal and air, and wherein the first and second plurality of air passages of the air shroud are operative to direct the secondary stream of air over an outer surface of the inner nozzle tip portion; and a pair of opposing lever pins operative to secure the inner nozzle tip portion to the pair of opposing lateral outer sidewalls, the pair of opposing lateral inner sidewalls, the pair of spacer plates, and the seal frame structure of the outer nozzle tip portion, wherein the inner nozzle tip portion is tiltably secured to the outer nozzle tip portion for longitudinal movement relative to the outer nozzle tip portion.

The pulverized coal fuel nozzle tip assembly of the preceding clause, wherein each of the spacer plates comprises a front surface having a contoured surface defining a plurality of spaced recesses, wherein the inner nozzle tip portion comprises a pair of opposing sidewalls, each having a back surface with a contoured surface defining a plurality of spaced of noses that are adapted for seating correspondingly in the plurality of spaced recesses, and wherein the corresponding seating of the noses with the recesses provides an outer nozzle tip portion to inner nozzle tip portion contact surface at locations of the seatings and at locations extending between the seating locations of the noses and the recesses.

The pulverized coal fuel nozzle tip assembly of any of the preceding clauses, wherein the outer nozzle tip portion to inner nozzle tip portion contact surface directs tilting forces used to tilt the inner nozzle tip portion to be applied to the outer nozzle tip portion, minimizing the tilting forces applied to the inner nozzle tip portion.

The pulverized coal fuel nozzle tip assembly of any of the preceding clauses, further comprising a pair of opposing lever pin mounting bores, each extending correspondingly through the opposing lateral outer sidewalls, the lateral inner sidewalls, the spacer plates, and the seal frame structure of the outer nozzle tip portion and outer sidewalls of the inner nozzle tip portion; and a pair of bushings, each placed in one of the opposing lever pin mounting bores to rotatably support one of the lever pins.

The pulverized coal fuel nozzle tip assembly of any of the preceding clauses, wherein the first and second plurality of air passages of the air shroud each comprises a curved outer portion to deflect the secondary air over the outer surface of the inner nozzle tip portion, and wherein the first plurality of air passages deflects the secondary air over a top surface of the inner nozzle tip portion and the second plurality of air passages deflects the secondary air over a bottom surface of the inner nozzle tip portion.

What is claimed is:

1. A pulverized solid fuel nozzle tip assembly adapted for cooperative operation with a pulverized solid fuel pipe nozzle to issue a stream of pulverized solid fuel and air to a pulverized solid fuel-fired boiler, comprising:
an outer nozzle tip portion adapted for mounting in supported relation with the pulverized solid fuel pipe nozzle, the outer nozzle tip portion having an inlet end, an outlet end, and a flow channel extending there through from the inlet end to the outlet end, wherein the outer nozzle tip portion includes:
a pair of opposing lateral sidewalls;
a seal frame structure located interior to the pair of opposing lateral sidewalls and coupled therewith, the seal frame structure having a top seal blade, a bottom seal blade, and a pair of opposing sidewall seal blades interconnected with the top seal blade and the bottom seal blade; and
an air shroud adapted to receive a secondary stream of air, the air shroud having a first plurality of air passages located on the top seal blade of the seal frame structure, secured between the pair of opposing lateral sidewalls, and a second plurality of air passages located under the bottom seal blade of the seal frame structure, secured between the pair of opposing lateral sidewalls, both the first plurality of air passages and the second plurality of air passages are adapted to produce different flow pathways for the secondary stream of air; and
a monolithic, ceramic, inner nozzle tip portion adapted for mounting within the outer nozzle tip portion, the inner nozzle tip portion having an inlet end, an outlet end, and a flow passageway formed therebetween, wherein the inner nozzle tip portion is tiltably secured to the outer nozzle tip portion for longitudinal movement relative to the outer nozzle tip portion, wherein the flow passageway of the inner nozzle tip portion is operative to receive the stream of pulverized solid fuel and air, and wherein the first and second plurality of air passages of the air shroud are operative to direct the secondary stream of air over an outer surface of the inner nozzle tip portion.

2. The pulverized solid fuel nozzle tip assembly according to claim 1, further comprising a pair of opposing lever pins operative to secure the inner nozzle tip portion to the lateral sidewalls of the outer nozzle tip portion.

3. The pulverized solid fuel nozzle tip assembly according to claim 2, wherein each of the pair of opposing lever pins is positioned in a central location relative to the corresponding lateral sidewalls and the sidewall seal blades of the seal frame structure on a lateral centerline, to facilitate titling of the inner nozzle tip portion over a predetermined a tilt range.

4. The pulverized solid fuel nozzle tip assembly according to claim 2, further comprising:
a pair of opposing lever pin mounting bores, each extending through one of the corresponding lateral sidewalls of the outer nozzle tip portion and one of a pair of sidewalls of the inner nozzle tip portion and the seal frame structure; and
a pair of bushings, each placed in one of the opposing lever pin mounting bores to rotatably support one of the lever pins.

5. The pulverized solid fuel nozzle tip assembly according to claim 1, wherein the inner nozzle tip portion comprises at least one splitter plate disposed in the flow passage that is operative to divide and direct the stream of pulverized solid fuel and air into different pathways.

6. The pulverized solid fuel nozzle tip assembly according to claim 1, wherein the pair of opposing lateral sidewalls of the outer nozzle tip portion comprises:
a pair of opposing lateral outer sidewalls;
a pair of opposing lateral inner sidewalls located interior and parallel with the pair of opposing lateral outer sidewalls; and
a pair of spacer plates separating the pair of opposing lateral outer sidewalls and the pair of opposing lateral inner sidewalls.

7. The pulverized solid fuel nozzle tip assembly according to claim 6, wherein the seal frame structure is located interior to the pair of opposing lateral inner sidewalls and coupled therewith, and wherein the pair of opposing lateral outer sidewalls and the pair of opposing lateral inner sidewalls extend vertically beyond the top seal blade and the bottom seal blade.

8. The pulverized solid fuel nozzle tip assembly according to claim 7, wherein the first plurality of air passages of the air shroud are located on the top seal blade of the seal frame structure secured between the pair of opposing lateral outer sidewalls and the pair of opposing lateral inner sidewalls, and the second plurality of air passages of the air shroud are located under the bottom seal blade of the seal frame structure secured between the pair of opposing lateral outer sidewalls and the pair of opposing lateral inner sidewalls.

9. The pulverized solid fuel nozzle tip assembly according to claim 6, wherein each of the spacer plates comprises a front surface having a contoured surface defining a plurality of spaced recesses.

10. The pulverized solid fuel nozzle tip assembly according to claim 9, wherein the plurality of spaced recesses comprises:
a lower recess at a lower heightwise location;
an upper recess at an upper heightwise location, and
a central recess centrally located between the lower recess and the upper recess.

11. The pulverized solid fuel nozzle tip assembly according to claim 10, wherein the central recess comprises a depth and width that is greater than the depth and width of the lower recess and the upper recess.

12. The pulverized solid fuel nozzle tip assembly according to claim 10, wherein the inner nozzle tip portion comprises a pair of opposing sidewalls, each having a back surface with a contoured surface defining a plurality of spaced of noses.

13. The pulverized solid fuel nozzle tip assembly according to claim 12, wherein the plurality of spaced noses for each of the opposing sidewalls of the inner nozzle tip portion comprises:
a lower nose at a lower heightwise location;
an upper nose at an upper heightwise location; and
a central nose centrally located between the lower nose and the upper nose.

14. The pulverized solid fuel nozzle tip assembly according to claim 13, wherein the lower nose, the upper nose, and the central nose are seated correspondingly in the lower recess, the upper recess, and the central recess of each of the spacer plates of the outer nozzle tip portion to provide an outer nozzle tip portion to inner nozzle tip portion contact surface at locations where the noses are correspondingly seated in the recesses, and at locations extending between the seating locations of the noses and the recesses.

15. The pulverized solid fuel nozzle tip assembly according to claim 14, wherein the outer nozzle tip portion to inner nozzle tip portion contact surface directs tilting forces used to tilt the inner nozzle tip portion to be applied to the outer nozzle tip portion, minimizing the tilting forces applied to the inner nozzle tip portion.

16. A pulverized coal nozzle tip assembly adapted for cooperative operation with a pulverized coal pipe nozzle to issue a stream of pulverized coal and air to a coal-fired boiler, comprising:
an outer nozzle tip portion adapted for mounting in supported relation with the pulverized coal pipe nozzle, the outer nozzle tip portion having an inlet end, an outlet end, and a flow channel extending there through from the inlet end to the outlet end, wherein the outer nozzle tip portion includes:
a pair of opposing lateral outer sidewalls;
a pair of opposing lateral inner sidewalls located interior and parallel with the pair of opposing lateral outer sidewalls;
a pair of spacer plates separating the pair of opposing lateral outer sidewalls and the pair of opposing lateral inner sidewalls;
a seal frame structure located interior to the pair of opposing lateral inner sidewalls and coupled therewith, the seal frame structure having a top seal blade, a bottom seal blade, and a pair of opposing sidewall seal blades interconnected with the top seal blade and the bottom seal blade, wherein the pair of opposing lateral outer sidewalls and the pair of opposing lateral inner sidewalls extend vertically beyond the top seal blade and the bottom seal blade; and
an air shroud adapted to receive a secondary stream of air, the air shroud having a first plurality of air passages located on the top seal blade of the seal frame structure, secured between the pair of opposing lateral outer sidewalls and the pair of opposing lateral inner sidewalls, and a second plurality of air passages located under the bottom seal blade of the seal frame structure, secured between the pair of opposing lateral outer sidewalls and the pair of opposing lateral inner sidewalls, both the first plurality of air passages and the second plurality of air passages are adapted to produce different flow pathways for the secondary stream of air;
a monolithic, ceramic, inner nozzle tip portion adapted for mounting within the outer nozzle tip portion, the inner nozzle tip portion having an inlet end, an outlet end, and a flow passageway formed therebetween, wherein the flow passageway of the inner nozzle tip portion is operative to receive the stream of pulverized coal and air, and wherein the first and second plurality of air passages of the air shroud are operative to direct the secondary stream of air over an outer surface of the inner nozzle tip portion; and
a pair of opposing lever pins operative to secure the inner nozzle tip portion to the pair of opposing lateral outer sidewalls, the pair of opposing lateral inner sidewalls, the pair of spacer plates, and the seal frame structure of the outer nozzle tip portion, wherein the inner nozzle tip portion is tiltably secured to the outer nozzle tip portion for longitudinal movement relative to the outer nozzle tip portion.

17. The pulverized coal fuel nozzle tip assembly according to claim 16, wherein each of the spacer plates comprises a front surface having a contoured surface defining a plurality of spaced recesses, wherein the inner nozzle tip portion comprises a pair of opposing sidewalls, each having a back surface with a contoured surface defining a plurality of spaced of noses that are adapted for seating correspondingly in the plurality of spaced recesses, and wherein the corresponding seating of the noses with the recesses provides an outer nozzle tip portion to inner nozzle tip portion contact surface at locations of the seatings and at locations extending between the seating locations of the noses and the recesses.

18. The pulverized coal fuel nozzle tip assembly according to claim 17, wherein the outer nozzle tip portion to inner nozzle tip portion contact surface directs tilting forces used to tilt the inner nozzle tip portion to be applied to the outer nozzle tip portion, minimizing the tilting forces applied to the inner nozzle tip portion.

19. The pulverized coal fuel nozzle tip assembly according to claim 16, further comprising:
a pair of opposing lever pin mounting bores, each extending correspondingly through the opposing lateral outer sidewalls, the lateral inner sidewalls, the spacer plates, and the seal frame structure of the outer nozzle tip portion and outer sidewalls of the inner nozzle tip portion; and
a pair of bushings, each placed in one of the opposing lever pin mounting bores to rotatably support one of the lever pins.

20. The pulverized coal fuel nozzle tip assembly according to claim 16, wherein the first and second plurality of air passages of the air shroud each comprises a curved outer portion to deflect the secondary air over the outer surface of the inner nozzle tip portion, and wherein the first plurality of air passages deflects the secondary air over a top surface of the inner nozzle tip portion and the second plurality of air passages deflects the secondary air over a bottom surface of the inner nozzle tip portion.
